(19) United States
(12) Patent Application Publication
(10) Pub. No.: US 2024/0081341 A1
(43) Pub. Date: Mar. 14, 2024

(54) ENCAPSULATION OF INSECTICIDES INTO BIOPOLYMER CAPSULES

(71) Applicants: UNM RAINFOREST INNOVATIONS, Albuquerque, NM (US); Fundacao Oswaldo Cruz, Rio de Janeiro (BR)

(72) Inventors: Alexandra Victoria Yingling, Albuquerque, NM (US); Ivy Foo-Hurwitz, Albuquerque, NM (US); Linnea Ista, Albuquerque, NM (US); Scott Matthews, Williamsville, NY (US); Fernando Genta, Rio de Janeiro (BR); Bruno Gomes, Rio de Janeiro (BR)

(21) Appl. No.: 18/382,589

(22) Filed: Oct. 23, 2023

Related U.S. Application Data
(63) Continuation-in-part of application No. 17/469,135, filed on Sep. 8, 2021.
(60) Provisional application No. 63/076,041, filed on Sep. 9, 2020.

(51) Int. Cl. A01N 63/32; A01N 25/10; A01N 25/26; A01N 63/23; A01P 7/04

(52) U.S. Cl. CPC A01N 63/32; A01N 25/10; A01N 25/26; A01N 63/23; A01P 7/04

(57) ABSTRACT

The present invention describes capsule compositions consisting of crosslinked chitosan, beta-glucan or alginate, and encapsulates an environmentally compatible insecticide, especially larvicidal agents such as essential oils or essential oil components or other ingestible larvicides such as Bacillus thuringiensis which are lethal to the larvae and adults of pest insects, especially mosquito larvae.

### FIELD OF THE INVENTION

This invention is directed to novel compositions which comprise a biopolymer capsule of chitosan, beta-glucan, and/or alginic acid (alginate), each of which is often crosslinked, and encapsulates an environmentally compatible ingestible larvicide or insecticide comprised of larvicidal/insecticidal agents such as essential oils, components of essential oils or Bacillus thuringiensis (Bti), which are lethal to insect larvae and adult insects, and are especially lethal to mosquito larvae. The capsule also enables durable protection from environmental factors such as UV radiation, extreme temperatures, and mechanical stress associated with field application.

### RELATED APPLICATIONS

This application claims the benefit of priority of U.S. patent application Ser. No. 17/469,135, filed Sep. 8, 2021, the entire contents of which are incorporated by reference herein.

### BACKGROUND AND OVERVIEW OF THE INVENTION

Significant resources are devoted to limiting and/or controlling various “pest” insect populations that are known to be pathogen carriers of human and/or non-human disease and/or are linked to the destruction of crops and/or other undesired outcomes. For example, mosquitos are known vectors of diseases including, but not limited to, malaria (Anopheles) Zika virus, dengue virus, yellow fever (Aedes), and West Nile virus (Culex). Accordingly, it is highly desirable to manage the population of pest insects at the larval stage before the insects are able transmit diseases or decimate crops.

The need for vector control measures is particularly common in rural and resource-poor communities. As such, successful vector control methods are simple, low cost solutions that are easy to deploy and sustainable as mutli-year interventions.

The most commonly used method for limiting and/or controlling undesirable insect populations are pesticides, which can be harmful to humans and/or non-target species. In an attempt to control mosquito populations, many communities resort to adding synthetic pesticides to water reservoirs, including sources of potable water. This poses a health risk to these communities, as synthetic pesticides utilize neurotoxins and growth inhibitors. Furthermore, the costly manufacturing processes, storage, and transport of these synthetic pesticides present potential health hazards to humans and/or other non-target species.

Other methods for controlling insect populations, such as the engineering of genetically modified insects, are expensive and limited in application for a specific variety of mosquito (Aedes). Furthermore, genetic modification may not be the most effective method for vector control as it may not be possible to control the movement or migration of an insect population. Finally, as this technology is new and largely untested, it is difficult to predict the long-term consequences and efficacy of releasing genetically modified populations of mosquitos.

Recently, methods of controlling pest insect populations that are non-toxic to humans, animals, and/or desirable insect populations, but toxic to undesirable insect populations have been introduced. One such method utilizes essential oils, which are non-toxic (to humans and other animals) but are effective in killing insect larvae. However, the use of essential oils to control or limit pest population is difficult as rather large amounts of essential oil have to be added repeatedly to oviposition sites to achieve significant reduction in the pest population. Moreover, the dispersed oils are vulnerable to degradation by UV radiation and other environmental factors and otherwise disrupt the aquatic environment. Accordingly, an effective mechanism for delivering essential oils directly to the pest larvae population is greatly desired.

Recently, yeast-encapsulated larvicide has been introduced and represents a novel and effective approach for controlling mosquito larvae populations. In a current formulation, the yeast-encapsulated larvicide is optimized for application into areas with standing water (cisterns, ponds, etc.). However, Aedes mosquitoes breed in small containers in areas around the home. Further, Aedes eggs can withstand desiccation, hatching only when the rains come.

In this application, the inventors report the development of an innovative approach to package their previously patented (U.S. Pat. No. 10,555,519 entitled “Novel Non-Toxic Larvicide”) larvicide, which is incorporated by reference in its entirety herein. In repeated laboratory testing, the patented larvicide kills Aedes and Culex larvae rapidly with an LD₉₀ of less than 30 ppm in 24 hours (Workman et al, Parasit Vectors, 2020).

The present invention is designed for site pre-treatment as well as extended release using polymeric capsules based upon chitosan, beta-glucan and/or alginic acid (alginate). The formulations of the present invention will protect the larvicide/adulticide upon application to both dry and wet treatment sites. When applied to dry sites, the presented formulation will rapidly release larvicide/adulticide upon hydration (e.g. rain, dew, etc). Ingestion of the larvicide/adulticide by hatching larvae (i.e. from mosquito eggs left in the area during previous rain fall, or freshly laid eggs) or adult insects will result in death, thereby providing the site with larval/insect source management. The disclosed capsules will also protect the larvicide/adulticide from premature water-induced degradation and degradation by UV radiation. Controlled and extended release is achieved by modulating capsule swelling using crosslinkers. When applied to cisterns or ponds, these capsules will activate, gradually releasing larvicide/insecticide for larval source or insect pest control over a period of at least two weeks to 4-6 weeks or more, including up to 2-3 months or a year.

### BRIEF DESCRIPTION OF THE INVENTION

The present invention describes an environmentally compatible capsule, comprising chitosan, beta-glucan, alginic acid (alginates) or mixtures thereof, which encapsulates ingestible environmentally compatible active compositions which comprise active compounds or other components of essential oils, including larvicides and/or adulticides (“insecticides”) and insect repellents. Specifically, the active compositions (e.g. larvicides/adulticides and/or repellents) include yeast-encapsulated essential oil components and/or essential oils, other essential oil components and/or essential oils which are not yeast-encapsulated and other ingestible larvicides/adulticides, such as Bti, among others, which are released from the capsules upon hydration or through direct physical contact (for example by an insect or animal). In embodiments, when ingested, these active compositions (larvicides/adulticides) are lethal to the targeted species of insect larva or adult insects. In embodiments, these active essential oil components function as deterrents or pest repellents.

In an embodiment, compositions according to the present invention comprise microparticles which are prepared by spray drying and/or encapsulating active compositions, including larvicide and/or adulticide components and/or insect repellents, preferably yeast-encapsulated larvicide, with chitosan, beta-glucan and/or alginic acid as described herein. In embodiments, the larvicidal/adulticidal or repellent agent, specifically essential oil components and/or essential oils or other ingestible larvicides/adulticides as otherwise described herein, may be directly (i.e., without first being encapsulated with yeast) spray dried (to preferably provide microcapsules of chitosan, beta-glucan and/or alginic acid) or alternatively, the larvicide/adulticide is first encapsulated in yeast (S. cerevisiae as fresh or dried baker's yeast) before being further encapsulated. In embodiments, the microparticles or the yeast-encapsulated larvicide are then further encapsulated and preferably crosslinked with chitosan, genipin, beta-glucan and/or alginic acid in a crosslinker solution resulting in the final capsules. These final capsules are then used directly or alternatively, can be further formulated into tablets for distribution into the environment.

Thus, in embodiments, the present invention is directed to microparticles comprising larvicide or yeast-encapsulated larvicide/adulticide particles, which are further encapsulated with ingestible, preferably crosslinked biopolymer comprising crosslinked chitosan, beta-glucan, and/or alginic acid. These capsules may be used directly or formulated into tablets or other delivery forms. Pursuant to the present invention, the release of active component (larvicide, adulticide and/or insect repellent) from the capsules may be modified to provide a quick/immediate release or a delayed and/or sustained release in order to exhibit maximum effect on larval or adult insect populations, depending upon the larva or adult insect to be impacted and the environmental conditions under which the active component (as a larvicide/adulticide or an insect repellent) is released from the capsules and/or the microparticles.

In embodiments, the compositions comprise 0.1% to 35% by weight active component as a larvicide, adulticide and/or repellant. Often the compositions comprise about 0.5% to about 15% by weight active component, often a larvicide and/or adulticide, even more often about 1% to about 10% by weight active component, the remaining portion of the capsule comprising biopolymer, which is often crosslinked. In embodiments, yeast-encapsulated active component, often a larvicide and/or adulticide or the microparticles described which contain active component, are further encapsulated with crosslinked chitosan, beta-glucan, and/or alginic acid. Yeast encapsulated active component (often a larvicide and/or adulticide, more often a larvicide), when used, comprises about 1% to about 95% or 5% to 90%, often 10% to 85%, 15% to 65%, 5% to 25% or 25% to 75% by weight of the encapsulated active component and crosslinked polymer taken together (i.e., the final weight of the capsules). Active component microparticles, when used, comprise 1% to 99%, often 5% to 85%, 10% to 80%, 25% to 75%, 15% to 25% or 30% to 65% by weight of the active component containing microparticles and crosslinked polymer taken together. The capsules comprise 1% to 99%, often 5% to 99%, 15% to 95%, 25% to 95% or 35% to 75% by weight crosslinked polymer selected from the group consisting of chitosan, beta-glucan, lignin, and/or alginic acid, each of which preferably is crosslinked with from about 0.05% to about 10% by weight crosslinker, often about 0.1% to about 7.5% by weight crosslinker, about 0.5% to about 2.5% by weight crosslinker (based upon the weight of crosslinker and polymer within the capsule). In certain embodiments, the biopolymer remains uncrosslinked in order to facilitate release of active component from the capsule, for example, by way of immediate release or physical impact (such as an animal body rubbing against the capsules).

In embodiments of the present invention, chitosan and beta-glucan are crosslinked with about 0.05 to 10.0%, often 0.1% to 5%, more often about 0.5% to about 2.5% by weight glutaraldehyde, gelatin or genipin. In embodiments, chitosan also may be crosslinked with about 0.05% to about 7.5% by weight, often about 0.1% to about 5%, even more often about 0.5% to 2.5% by weight tripolyphosphate as crosslinker. In embodiments, alginic acid is crosslinked with a divalent cation such as Ba²⁺, Mg²⁺, Ca²⁺, Sr²⁺, in an amount ranging from about 0.01% to about 5.0%, or 0.1% to 2.5%, often about 0.05% to about 1% by weight of divalent cation to polymer.

In embodiments, the active component is a component which is often found in essential oils as a primary or secondary component (essential oil active component) and has larvicidal/insecticidal and/or repellant properties. In embodiments, the active component is an active component of an essential oil (an active essential oil component), often a monoterpenoid (monoterpene) component of an essential oil, or the active component is included in an essential oil. Active components comprise at least about 20% by weight of the essential oil or essential oil components used in the present invention.

In embodiments, the active component is selected from the group consisting of 1,8-cineole (eucalyptol), a-bisabolol (levomenol), a-cedrene, a-phellandrene, a-pinene, a-santalol, a-terpineol, b-caryophyllene, b-cedrene, b-phellandrene, b-pinene, b-santalol, b-turmerone, benzyl alcohol, benzyl benzoate, bornyl acetate, callitrisic acid, camphor, carotol, carvacrol, carvone, caryophyllene, chamazulene, cinnamaldehyde, citral, citronellal, citronellol, cuminaldehyde, davanone, elemol, eremophilone, estragole, eugenol, eugenol acetate, g-3-carene, g-terpinene, geranial, geraniol, geranyl acetate, guaiol, isopinocamphone, kahweol, ledene, ledol, limonene, linalool, linalyl acetate, menthol, methyl eugenol, myrcene, nepetalactone, neryl acetate, nootkatone, patchoulol, pinocamphone, piperitone, sabinene, sedanolide, terpinenol, thujone, thymol, trans-anethole, valencene, valeranone, vanillin, vetiverol, vetiverone and mixtures thereof.

In embodiments, the active component often is selected from the group consisting of 1,8-cineole (eucalyptol), a-bisabolol (levomenol), a-terpineol, carvacrol, carvone, cuminaldehyde, estragole, eugenol, eugenol acetate, g-3-carene, g-terpinene, geranyl acetate, limonene, linalool, linalyl acetate, menthol, methyl eugenol, myrcene, nepetalactone, neryl acetate, piperitone, sabinene, terpinenol, thymol, trans-anethole and mixtures thereof. In embodiments, the active component is selected from the group consisting of carvone, citral, citronellal, eugenol, g-terpinene, geraniol, limonene, myrcene, nootkatone, trans-anethole and mixtures thereof.

In embodiments, the active component(s) is a component found in an essential oil such that the essential oil comprises at least 20% by weight active component(s) and is used directly or with minor processing in the present invention. Exemplary essential oils include for example, orange oil, mandarin orange oil, tangerine oil, lime oil, lemon oil, grapefruit oil, bergamont oil, juniper berry oil, spearmint oil, caraway oil, dill seed oil, carrot seed oil, parsley seed oil, clove bud oil, clove leaf oil, neem oil, cinnamon leaf oil, allspice oil, bay laurel oil, marjoram oil, juniper berry oil, eucalyptus oil, hops oil, cardamom oil, peppermint oil, fennel oil, anise oil, tarragon oil, star anise oil, eucalyptus oil (various types), pine needle oil, thyme oil, oregano oil, oregano oil, thyme oil, savory oil and tea tree oil, among others.

In embodiments, the essential oil used in the present invention is selected from the group consisting of orange oil, mandarin orange oil, tangerine oil, lime oil, lemon oil, grapefruit oil, fennel oil, anise oil, star anise oil, thyme oil, oregano oil, basil oil, peppermint oil, clove bud oil, neem oil or a mixture thereof.

In embodiments, the active component is a larvicide and the larvicide is Bti (Bacillus thuringiensis subspecies israelensis), which is a naturally occurring bacterium found in soil which produces toxins to insect larva, especially mosquito, blackfly and fungus gnat larva. In embodiments the larvicide is a mixture of an essential oil/active essential oil component and Bti. In embodiments, the essential oil is orange oil (which term includes sweet orange oil), fennel oil, thyme oil, basil oil, peppermint oil, clove bud oil, neem oil or a mixture thereof.

In an embodiment, the present invention is directed to a method for eradicating a targeted insect population often an insect larvae population, more often a mosquito larval population. In embodiments the targeted insect population is an adult insect population. In embodiments, the method comprises exposing a target population of insects, including adult insects and/or insect larva to an effective amount of a composition according to the present invention. In preferred embodiments, the present invention targets different species of Aedes, Culex and Anopheles mosquitos (larvae and adult, but often larvae). Particularly important Aedes spp. which may be targeted by the present invention include, but are not limited to Ae. aegypti, Ae. albopictus, Ae. japonicus, which are vectors for the zika virus, yellow fever virus and chikungunya virus. Particularly important Culex spp. which may be targeted by the present invention include, but are not limited to Cx. pipiens, Cx. tarsalis, Cx. Quinquefasciatus, which are vectors for West Nile virus, Japanese encephalitis virus, and Saint Louis encephalitis virus, among others. Important Anopheles spp. which may be targeted by the present invention include, but are not limited to An. atropavrus, An. albimanus, An. arabiensis, An. barberi, An. bellator, An. crucians, An. cruzii, An. culcifacies, An. darlingi, An. Deaneorum An. dirus, An. earlei, An. freeborni, An. fenestus, An. gambiae, An. introlatus, An. latens, An. maculipennis, An. moucheti, An. nili, An. punctipennis, An. quadrimaculatus, An. stephensi, An. subpictus, An. sundaicus, An. walkeri. Particularly important Anopheles spp. including An. freeborni and An. quadrimaculatus in the United States, An. gambiae, An. funestus and An. Arabiensis in Africa, An. leucosphyrus and An. dirus in Asia and An. darlingi, An. marajoara, and An. deaneorum in Latin America. Anopheles spp. mosquitoes are often vectors for Plasmodium spp. malaria, including malaria caused by P. falciparum, P. vivax, P. ovale and P. malariae with P. falciparum malaria being the most deadly form.

In embodiments, compositions according to the present invention also include an effective amount of additional agents/components which have UV protective character (especially UVC protection) and instill that protection to the final composition. These agents include, for example, India ink, zinc oxide, titanium dioxide, silicon dioxide, lignin, lycopene and alumina/aluminum oxide (including in various colors such as red, yellow, white and black) all in effective amounts, often at a weight percentage of the final composition ranging from 0.1% to 2.5-3.0% by weight, more often 0.5 to 1.5% by weight of the final composition. These agents are often added during synthesis of the capsules in order to incorporate the agents/component into the final composition. These agents, especially silicon dioxide and alumina also may be used as a carrier for other UV-blocking agents as well as enhancing the scattering of UV rays.

### BRIEF DESCRIPTION OF THE FIGURES

FIG. 1 shows the chemical structure of chitosan repeat units in chitosan polymers used in embodiments according to the present invention. Shown is the chitosan repeat unit (n=50-2500, often 1000-1500) and the end unit chemical structures.

FIG. 2 shows the Beta-1,3-glucan repeat and end unit chemical structure. n is typically 50-2500, often 1000-1500.

FIG. 3 shows the alginate chemical structure comprising repeat units of L-Guluronic acid (m=50-1500, more often 500-1000, left) and D-Mannuronic acid (n=50-1500, more often 500-1000, right).

FIG. 4 shows an egg-box structure as a result of polymer crosslinking.

FIG. 5 shows the total percent cells released from the alginate bead into water for a period of up to 30 days. The alginate-larvicide mixture was crosslinked for 5, 20, and 30 minutes with 1% CaCl₂) to form the larvicide-laden alginate beads.

FIG. 6 shows a flow chart of chemical components of essential oils.

### DETAILED DESCRIPTION OF THE INVENTION

The present invention provides a novel capsule based upon crosslinked polymers selected from chitosan, beta-glucans, alginic acid, and mixtures thereof that are ingestible by and toxic to targeted species and non-toxic to humans and non-target species. This formulation, which is cost-effective to manufacture, provides targeted larvicide/adulticide release that allows for maximum impact of larvicide and insecticides on targeted insect larvae and adult insects and provides for significant flexibility in the concentration and timing of the release of larvicide/adulticide. The present disclosure also provides methods for making and using the novel capsule.

For the purposes of the present disclosure, the target larvae or target species refers to the intended target of the larvicide/adulticide. While many of the specific embodiments provided herein refer to mosquito larvae as the intended target, it will be understood that larvae of other insects or other species, including adult insect pests may also be the intended target and that the larvicide/adulticide may be altered, as described herein, to be more particularly suited towards one target or another, including black flies and fungus gnat larvae, among others.

Furthermore, it will be understood that the novel larvicide described herein may be designed to be suitable for more than one target and that references to “a” or “the” target species does not necessarily preclude embodiments wherein there is more than one target species. In embodiments, the targeted larvae is mosquito (various species of Aedes, Culex and Anopheles), black fly or fungus gnat larvae.

According to various embodiments, the novel capsule comprises a larvicide/adulticide encapsulated into a polymer matrix consisting of crosslinked chitosan, beta-glucan, alginic acid, and mixtures thereof. In embodiments, the polymer matrix is uncrosslinked. According to various embodiments, the larvicide/adulticide is a substance that is non-toxic to humans and other non-target species, but which negatively impacts the ability of the target species to behave in an undesirable manner. According to a specific embodiment, the larvicidal agent is often an essential oil or a bacterium toxic to specific larvae such as Bti.

Essential oils are naturally produced by plants to provide protection from larvae and adult insects but are non-toxic to humans. Essential oils have been recognized as effective larvicides when added directly to the aqueous environment where larvae reside for over 30 years. Direct exposure to essential oils is believed to induce larvicidal effects through three different mechanisms: neurotoxicity, growth inhibition, and interruption of metabolic pathways. The simultaneous action of these mechanisms retards the evolution of resistance to the larvicide. However, the practicality of essential oil application in the field is challenging. Their hydrophobic nature makes them unsuitable for direct application into aquatic environments without causing disruptions to the ecosystem. Further, essential oils are susceptible to rapid degradation by ultraviolet (UV) radiation, temperature, and oxidation. As such, in one embodiment the inventors proposed the delivery of these effective larvicides by first encapsulating them into yeast cells, followed by further encapsulation as described herein. In other embodiments, the active essential oil components and/or essential oils are first spray dried and used directly or further encapsulated as described herein.

For the purposes of the present disclosure the term “capsule” is intended to mean a polymeric capsule, often crosslinked which is capable of encapsulating the larvicide/adulticide and generally sequestering it from the environment until the delivery vehicle is exposed to environmental elements which facilitates its release or ingested by the target species. The capsule is generally non-toxic to non-target species. The delivery vehicle should have sufficient durability in the environment in which it will encounter the target species so that it can withstand the conditions long enough for the released larvicide/adulticide to be ingested by or exposed to the target species. In most embodiments, the capsule comprises a crosslinked polymer of chitosan, beta-glucan or alginic acid. In embodiments, the larvicide/adulticide is first yeast-encapsulated before being spray-dried and/or further encapsulated in crosslinked polymer. In embodiments, the larvicide/adulticide is spray-dried directly (without being yeast encapsulated) and the spray-dried particles may be further encapsulated with polymer, which is preferably crosslinked. In embodiments, the spray dried particles are used directly without further encapsulation. According to some embodiments, the capsule may be inert to all or most environments that do not replicate the environmental conditions found in the digestive system of the target species.

Accordingly, in embodiments, the capsule may incorporate an inactive or non-viable yeast cell which encapsulates the larvicidal agent. According to a more specific embodiment, the capsule utilizes a non-viable yeast cell of the S. cerevisiae variety to encapsulate the larvicide prior to further encapsulation with crosslinked polymer. It is a well-documented feature of larval biology that mosquito larvae will readily digest S. cerevisiae. In fact, a recommended food for rearing larvae in laboratory settings is S. cerevisiae. Moreover, the cell membrane of yeast cells is rich in beta-glucan, a polysaccharide, and chitin. Larvae have intestinal enzymes specialized for the digestion of beta-glucan to rapidly break down ingested yeast cell membranes.

In embodiments, the insecticide or repellent is spray-dried with beta-glucan or chitin, alginic acid, starch or starch derivative, a cellulosic or other biopolymer to first provide microparticles which may be further encapsulated. In still other embodiments, the larvicide is directly encapsulated with crosslinked polymer as otherwise described herein.

In embodiments, insecticides often may be encapsulated, infused, injected, entrapped, loaded, etc. (referred to herein collectively as “encapsulated” for ease of discussion) into yeast cells using any suitable method depending on the specific larvicidal/insecticidal element and encapsulating polymer used to form capsules pursuant to the present invention. Examples of suitable methods for encapsulating the larvicidal element into yeast cells include, but are not limited to, a combination of heat and agitation, plasmolyzation, and coacervation as described in greater detail in the Examples section herein below.

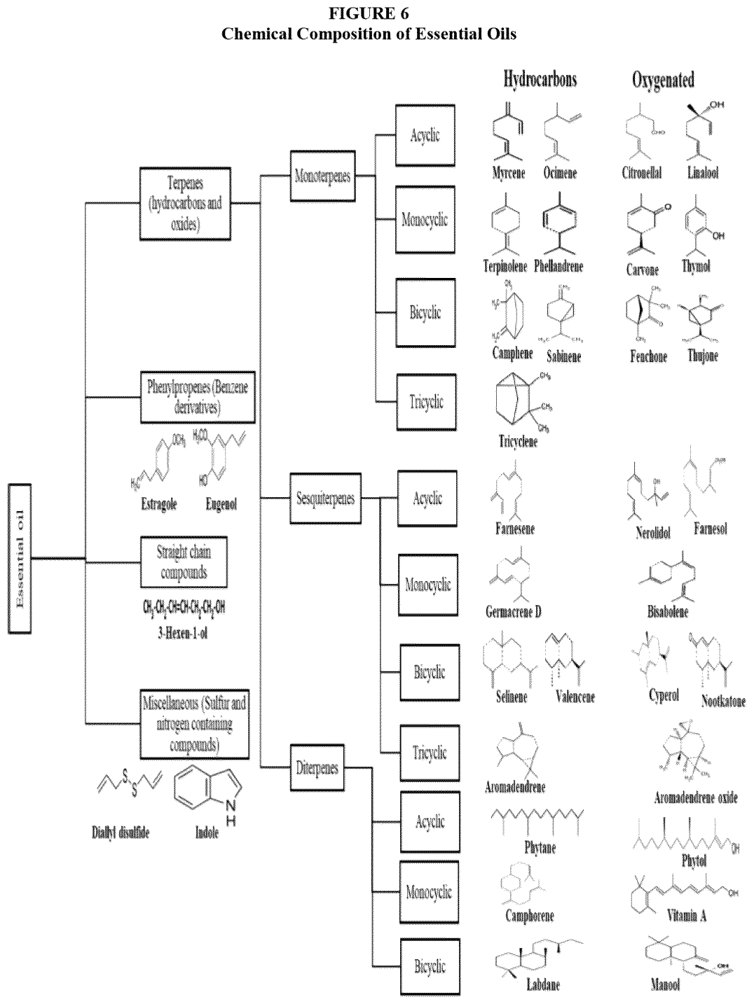

Essential oils are secondary metabolites produced by plants. The specific composition of essential oils can exhibit significant variability contingent upon multiple factors including but not limited to, geographical origin, cultivation and extraction techniques. Typically, each essential oil comprises a complex blend of between 20 to 60 individual chemical constituents. Within this chemical complexity, a subset of from 1 to 3 or more often 2 to 3 primary components, which usually constitute at least about 20% of the overall composition, will dominate. These primary constituents are composed of 4 different classes of compounds, including terpenes, phenylpropenes, straight-chain components, and other sulfur and nitrogen-containing components. These are identified in enclosed FIGURE 6. Monoterpenoids, including but not limited to limonene, trans-anethole, terpinene, thymol, carvone, linalool, menthol, and eugenol, which influence the aroma and potential larvicidal activities of the essential oils, often predominate. For example, limonene has been shown to disrupt the larvae's nervous system, ultimately leading to paralysis and mortality; trans-anethole impedes the growth and development of larvae, while carvone, disrupts larval respiration and metabolic processes. As such, essential oils comprising more than 20% of monoterpenoids with larvicidal/insecticidal potential as described herein often will be utilized for encapsulation.

According to a specific embodiment wherein a larvicidal/adulticidal capsule comprises a larvicide/adulticide as an essential oil or an active component of an essential oil in a mixture of essential oil components as the larvicide/adulticide and a yeast cell such as an S. cerevisiae cell, the yeast-encapsulated larvicide/adulticide may be further encapsulated with a crosslinked polymer as described herein. The heat and agitation method results in the encapsulation of all components of the essential oils without discrimination, including terpenes and aldehydes. However, molecules as large as 400 kDa can freely diffuse through the cell wall.

Once the essential oil enters the yeast cell, the yeast becomes nonviable and cannot replicate, thereby reducing or eliminating any potential impact on the environment during storage, transportation, and/or use. However, while the yeast cell is nonviable, the cell's thick outer membrane remains intact and thus sequesters the oil from the surrounding environment. As explained above, some target species, such as mosquito larvae have intestinal enzymes that are specialized for the digestion of beta-glucan, thus resulting in a system wherein the essential oil/yeast cell capsule is essentially inert to all environments it is likely to encounter other than the specialized digestive systems of the target mosquito larvae.

According to a specific embodiment of use, the capsules of the present disclosure could be distributed directly to dry mosquito or other insect breeding sites prior to rainfall. Upon hydration, the capsules will swell, releasing the microcapsules (containing larvicide) that will be ingested by hatching insect larvae such as mosquito larvae. Thus, the present microcapsules release larvicide during environmental conditions which serve to enhance larval population and growth.

In embodiments, the capsules of the present disclosure will further protect the microcapsules (containing larvicide/adulticide) from premature degradation when exposed to water. The capsule's rate of swelling can be modulated by the use of specific crosslinkers, as described herein including but not limited to divalent cations and genipin. This deliberate modulation of capsule swelling is critical for achieving controlled, extended release. When exposed to water, such as application into cisterns or ponds, these capsules become activated, resulting in the gradual release of the microcapsules into the breeding site for ingestion by larvae. This sustained dispersion would significantly reduce costs as applications often will be limited to once every 4-6 weeks or more.

The formulation of the present invention could be used in conjunction with existing municipal or rural larvicide/insecticide/other pest control programs. Furthermore, because the presently described system can be used in environments where traditional chemical larvicides and insecticides are not used due to safety risks, the presently described larvicidal/adulticidal system can be used in high-value breeding sites, specifically in urban areas.

The term “effective” is used to describe an amount of a polymer, larvicide/adulticide or other component used to provide encapsulated larvicide/adulticide according to the present invention which is provided and used to effect an intended result within the context of the use of the component. The term effective is also used to describe an amount of encapsulated larvicide/adulticide which is used to control insect larvae and other pests (adult) as otherwise described herein.

The terms “larvicide” and “adulticide” (collectively, “insecticides”) and “repellent” include essential oils and their active essential oil components and Bti and other ingestible materials which are toxic to a targeted organism (insect pest), especially insect larvae, but which are principally non-toxic to humans and other non-targeted organisms. In the case of insectides, these agents are sufficient toxic to induce death, whereas repellants, while less toxic than insecticides, repel the insect from the site of contact. Essential oils which are useful in the present invention include orange oil, mandarin orange oil, tangerine oil, lime oil, lemon oil, grapefruit oil, bergamont oil, juniper berry oil, spearmint oil, caraway oil, dill seed oil, carrot seed oil, parsley seed oil, clove bud oil, clove leaf oil, neem oil, cinnamon leaf oil, allspice oil, bay laurel oil, marjoram oil, juniper berry oil, eucalyptus oil, hops oil, cardamom oil, peppermint oil, fennel oil, anise oil, tarragon oil, star anise oil, eucalyptus oil (various types), pine needle oil, thyme oil, oregano oil, oregano oil, thyme oil, savory oil and tea tree oil, among others, often orange oil, fennel oil, thyme oil, basil oil, peppermint oil, clove bud oil, neem oil or a mixture thereof. In embodiments of the present invention, the essential oil is orange oil or fennel oil. In embodiments, the larvicide is encapsulated in a yeast (S. cerevisiae) cell as otherwise described herein.

The term “polymer” includes chitosan, beta-glucan, alginic acid and mixtures thereof as otherwise described in the present invention. Medium to high molecular weights of the alginate (1 to 1000 kDa, often 100-400 kDa as described herein) and chitosan (1 to 1000 kDa, often, 200-400 kDa as described herein) will be used in order to improve the protective and mechanical properties of the bead. Low molecular weight alginate (<100 kDa) or chitosan (<200 kDa) may be respectively incorporated into the capsules during processing in order to reduce the shear forces during manufacturing while still maintaining key properties. Alginate should be 10-30% methacrylated and chitosan should be ≥75% deacetylated in order to achieve optimum crosslinking of either polymer.

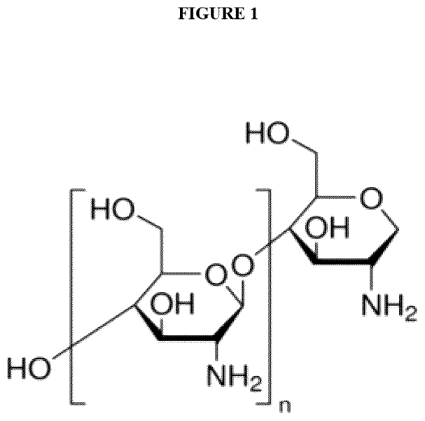

The term “chitosan” is used to describe a deacetylated derivative of chitin, which is a polysaccharide typically found in the exoskeletons of shrimp and crabs, among other crustaceans. The chemical structure of chitosan can be observed in FIG. 1. Chitosan has been shown to have antibacterial properties. The antibacterial properties of chitosan make it ideal for this formulation as it would protect the payload from bacteria interference when submerged in water. Further, mosquito larvae have been shown to readily ingest chitosan, so it should not act as a deterrent for the larvae. Medium to high molecular weights of chitosan are used in the present invention, often ranging from about 1 to 1000 kDA, often 25 to 1000 kDA, 50 to 1000 KDa, often 75-500 kDA, more often about 100 to 400 kDa. Small molecular weight chitosan may be added to formulations to enhance shear forces during manufacturing while maintaining the integrity of the final product produced. Chitosan should be ≥75% deacetylated in order to achieve optimum crosslinking of polymer.

The chemical structure of chitosan is presented in FIG. 1.

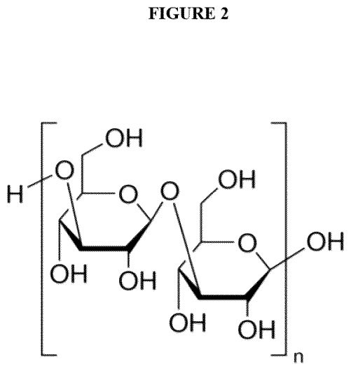

The term “beta-glucan” is used to describe a naturally occurring polysaccharide commonly found in the cell wall of S. cerevisiae (baker's yeast). This polysaccharide is what allows larvae to break down yeast in the gut. For this reason, the incorporation of beta-glucans is used to control digestion rates of the capsules in the larvae gut to target the most susceptible part of the gut. The formula for beta-glucans is shown in FIG. 2. The molecular weight of the beta-glucans ranges often ranges from about 50 to 1000 KDA, often 75-500 kDA, more often about 100 to 400 kDa.

FIG. 2 shows the Beta-1,3-glucan repeat and end unit chemical structure. n is typically 50-2500, often 1000-1500.

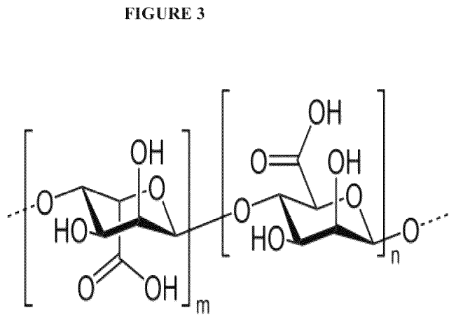

The term “alginate” or “alginic acid” is used to describe a UV-protective biopolymer found in the cell wall of Phacophycae (brown algae) that becomes a hydrogel in the presence of water. Alginate is widely used across agricultural, biomedical, and food industries due to simple protocols and ease of structural manipulation to control rates of release and degradation. FIG. 3 below shows the chemical structure of alginate. The ratios of L-guluronic acid and D-mannuronic acid blocks in alginate vary. In embodiments, the alginate is often methacrylated, more often at a level of 5% to 40%, more often at about 10% to about 30%.

FIG. 3 shows the alginate chemical structure comprising repeat units of L-Guluronic acid (m=50-1500, more often 500-1000, left) and D-Mannuronic acid (n=50-1500, more often 500-1000, right).

The term “crosslinking” is used to describe the bonding of long polymeric chains to each other through crosslinking agents at varying weight ratios to provide capsules according to the present invention. The types of crosslinking used in the formation of capsules pursuant to the present invention include chemical (covalent) crosslinking and physical (ionic) crosslinking. Chemical crosslinking utilizes covalent bonding to crosslink the polymers. This method allows different polymer chains to be crosslinked with each other. This method is used for the crosslinking of chitosan to the beta-glucans present in the yeast cell wall of the yeast-encapsulated essential oils. This process requires a chemical reagent that has reactive groups that can stimulate specific chemical groups in the polymers to link with each other. Traditional chemical crosslinking uses glutaraldehyde as a crosslinker. However, due to concerns with toxicity, gelatin and/or genipin are often used. For chitosan crosslinking, polytriphosphate may also be used. The unreacted crosslinking agent is typically removed after the crosslinking occurs.

Physical crosslinking is the crosslinking of a polymer via ionic bonds. Opposite charges between the polymer and crosslinker are necessary for the ionic bonds to form. For alginate, the ionotropic gelation technique is used and consists of exposing the alginate-larvicide solution to a divalent cation solution, for example using Ba²⁺, Sr²⁺, Ca²⁺, or Mg²⁺ cations. This crosslinking will transform the alginate-larvicide mixture into capsules that are then washed to remove residual crosslinkers to halt further crosslinking.

Crosslinker concentration and crosslinking time will vary depending on the polymer used to form the capsule, whether or not the larvicide is first encapsulated by yeast cells, the nature of the larvicide otherwise used and the release rate of the larvicide from the capsule. The process setup to create the capsules has several key factors that impact the rate of release by manipulating the structure of the polymer network. These primarily include crosslinker concentration and size, polymer concentration, and crosslinking time. For the crosslinker, increased concentration and size will yield a smaller pore size and the slower the encapsulated larvicide will diffuse. In embodiments which utilize yeast cell encapsulated larvicide, if the pore size is smaller than the larvicide encapsulated in yeast cells, the larvicide will not diffuse. The concentration of the polymer follows similarly. The higher the concentration of the polymer, the less pore space there is for the larvicide to release. In embodiments, divalent (Ba²⁺, Sr²⁺, Ca²⁺, or Mg²⁺) and covalent (gelatin) crosslinkers ranging from 0.5-15% aqueous solutions are often used. The percent solution will be dependent upon the selected crosslinker due to differences in chemical structures, cation size and the ability of the covalent crosslinkers to bond.

### Formation of Capsules

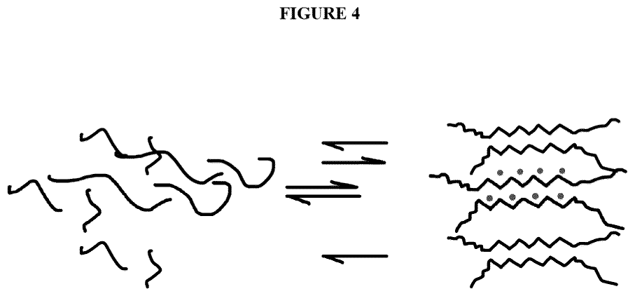

The polysaccharides used to form capsules pursuant to the present invention naturally exist in a liquid state. In order to create solid capsules out of these polysaccharides, crosslinking at some stage should occur. Crosslinking, described above, is the process of bonding polymer chains together through either covalent or ionic bonding. This crosslinking results in a porous structure that is conceptualized by what is known as the egg-box model, as seen in FIG. 4. In embodiments, these porous structures are gels. For example, polymers can be crosslinked to encapsulate the larvicide into the pores of the resulting structure.

FIG. 4 shows an egg-box structure as a result of polymer crosslinking.

Briefly, the larvicide/adulticide (i.e.: essential oil alone or in combination with additional components such as starch or a starch derivative, a cellulosic or other biopolymer or yeast-encapsulated essential oil) is coated with chitosan by spray drying. This method of encapsulation is conceptually similar to ionotropic gelation but is more readily scalable for manufacturing purposes and is commonly used in drug delivery applications. In an embodiment, the materials are combined and crosslinked via the spray dryer to yield dried microcapsules of larvicide encapsulated into polymer (e.g. chitosan, beta-glucan, alginate or a mixture thereof). The spray drying method and powder-like product may be more desirable for larger-scale manufacturing and applications. The polymer-covered (often chitosan) larvicide will then be thoroughly mixed into heated liquid polymer, often alginate, until the solution is homogenous. Capsules pursuant to the invention will be created by adding the larvicide-polymer (alginate) solution dropwise to a crosslinking solution (e.g. CaCl₂ or other crosslinking agent) and mixed for a predetermined amount of time (e.g. 5, 10, or 20 minutes) depending on the desired level of crosslinking. The capsules are then removed from the crosslinking solution and washed several times (e.g. 3× or more) with DI water and air dried for storage below ambient temperature (e.g. at 4° C.). This same or similar methods may be used to encapsulate larvicide into any of the polymers described herein, varying the concentration of polymer and the type and amount of crosslinker used to provide capsules pursuant to the present invention.

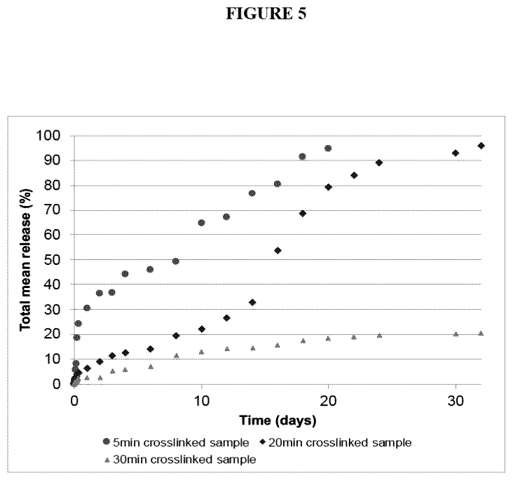

Increased exposure time of the polymer-larvicide mixture to the crosslinker allows for further crosslinking of the polymer resulting in smaller pores. Preliminary data (FIG. 5) explored the effect of crosslinking time (5, 20, and 30 minutes) for larvicide-laden alginate beads using 1% CaCl₂ as the crosslinking agent. The crosslinked alginate beads were placed in water and the release of larvicide cells from the bead was monitored for up to 30 days. The release of the larvicide from the beads was observed to be correlated with the crosslinking time. Specifically, the longer the bead was crosslinked, the slower the larvicide was released.

For purposes of the present application, Bti can be encapsulated by the polymers via ionotropic gelation or spray drying, methods well known in the art. For both applications, Bti is emulsified in water and then added to the polymer solution to prepare for the encapsulation process. It is otherwise treated as described above for the larvicide/adulticide (i.e.: essential oil or yeast-encapsulated essential oil).

FIG. 5 shows the total percent cells released from the alginate bead into water for a period of up to 30 days. The alginate-larvicide mixture was crosslinked for 5, 20, and 30 minutes with 1% CaCl₂) to form the larvicide-laden alginate beads.

In the case of using Bacillus thuringiensis (Bti) as larvicide, spores may be mixed with a polymeric solution and then crosslinked to form capsules. Alternatively, the Bti spores can be spray dried with starch or starch derivative, a cellulosic or other biopolymer and the spray dried particles encapsulated/crosslinked.

Mechanisms of Release

Release of encapsulated materials from a crosslinked polymer capsule can be achieved in two principal ways: diffusion or polymer degradation. Crosslinked polymer-larvicides capsules will swell once submerged in water. If the polymer has a low degree of crosslinking and is highly porous, the pores will swell enough to allow water to flow into the capsule and diffuse the encapsulated larvicide out into the environment to be ingested by mosquito larvae. The outer chitosan layer on the exterior of the larvicide cells will protect the product from microbial degradation. Enzymes within the larval gut will digest the chitosan layer protecting the larvicide upon ingestion.

The following exemplary method provides yeast S. cerevisiae encapsulated larvicide. Modifications to this approach may be readily made by the skilled practitioner. The essential oil, fresh baker's yeast (S. cerevisiae) and water are mixed in a weight ratio corresponding from 1:2:7 to 1:4.5:16, depending on the oil used, to provide Mixture 1. Mixture 1 is agitated in a rotary incubator at approximately 250 rpm at 40° C. for approximately 24 hrs (±1 hr).

Mixture 1 is then transferred to jars for centrifugation for 10 minutes at no more than 1700×g).
After decanting supernatant, consisting of excess oil, yeast and water, the cells are washed with ˜200 mL water. 30-60 mL of a 10% TWEEN solution is added to the mixture (depending on oil being used), and the fill jar to 400 mL with DI water, and mixed vigorously. The jars are centrifuged again with same settings as above. The washing step with the 10% TWEEN may be repeated depending on the selected oil. For all oils, following the 10% TWEEN wash(es), the washing step is repeated 3 more times without addition on the 10% TWEEN to remove all excess oil and detergent.
A final 50% (m/m) solution of wet yeast with H₂O is prepared if storing wet.
For lyophilization, an 80% (m/m) solution of wet yeast with H₂O is frozen for the freeze-drying process (48 hours).

The yeast-encapsulated larvicide is then subjected to further encapsulation using one or more polymers following the method as described above.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A capsule comprising an effective amount of insecticide or repellent encapsulated within a crosslinked polymer selected from the group consisting of chitosan, a beta-glucan, an alginate (alginic acid) or a mixture thereof.

2. The capsule according to claim 1 wherein said insecticide or repellent is a material selected from the group consisting of an essential oil or an essential oil component.

3. The capsule according to claim 1 wherein said insecticide or repellent is yeast-encapsulated essential oil and said yeast-encapsulated essential oil is further encapsulated within said polymer which is crosslinked.

4. The capsule according to claim 1 wherein said insecticide or repellent is an essential oil selected from the group consisting of orange oil, mandarin orange oil, tangerine oil, lime oil, lemon oil, grapefruit oil, bergamont oil, juniper berry oil, spearmint oil, caraway oil, dill seed oil, carrot seed oil, parsley seed oil, clove bud oil, clove leaf oil, neem oil, cinnamon leaf oil, allspice oil, bay laurel oil, marjoram oil, juniper berry oil, eucalyptus oil, hops oil, cardamom oil, peppermint oil, fennel oil, anise oil, tarragon oil, star anise oil, eucalyptus oil (various types), pine needle oil, thyme oil, oregano oil, oregano oil, thyme oil, savory oil, tea tree oil or a mixture thereof.

5. The capsule according to claim 1 wherein said insecticide is a larvicide selected from the group consisting of orange oil, mandarin orange oil, tangerine oil, lime oil, lemon oil, grapefruit oil, fennel oil, anise oil, star anise oil, thyme oil, oregano oil, basil oil, peppermint oil, clove bud oil, neem oil or a mixture thereof.

6. The capsule according to claim 5 wherein said larvicide is selected from the group consisting of orange oil, sweet orange oil, tangerine oil, fennel oil, thyme oil, basil oil, peppermint oil, clove bud oil, neem oil or a mixture thereof.

7. The capsule according to claim 1 wherein said insecticide or repellent is an active component of an essential oil comprising at least 20% by weight of a mixture of essential oil components.

8. The capsule according to claim 1 wherein said insecticide or repellent is selected from the group consisting of 1,8-cineole (eucalyptol), a-bisabolol (levomenol), a-cedrene, a-phellandrene, a-pinene, a-santalol, a-terpineol, b-caryophyllene, b-cedrene, b-phellandrene, b-pinene, b-santalol, b-turmerone, benzyl alcohol, benzyl benzoate, bornyl acetate, callitrisic acid, camphor, carotol, carvacrol, carvone, caryophyllene, chamazulene, cinnamaldehyde, citral, citronellal, citronellol, cuminaldehyde, davanone, elemol, eremophilone, estragole, eugenol, eugenol acetate, g-3-carene, g-terpinene, geranial, geraniol, geranyl acetate, guaiol, isopinocamphone, kahweol, ledene, ledol, limonene, linalool, linalyl acetate, menthol, methyl eugenol, myrcene, nepetalactone, neryl acetate, nootkatone, patchoulol, pinocamphone, piperitone, sabinene, sedanolide, terpinenol, thujone, thymol, trans-anethole, valencene, valeranone, vanillin, vetiverol, vetiverone and mixtures thereof.

9. The capsule according to claim 8 wherein said insecticide or repellent is selected from the group consisting of 1,8-cineole (eucalyptol), a-bisabolol (levomenol), a-terpineol, carvacrol, carvone, cuminaldehyde, estragole, eugenol, eugenol acetate, g-3-carene, g-terpinene, geranyl acetate, limonene, linalool, linalyl acetate, menthol, methyl eugenol, myrcene, nepetalactone, neryl acetate, piperitone, sabinene, terpinenol, thymol, trans-anethole and mixtures thereof.

10. The capsule according to claim 8 wherein said insecticide or repellent is selected from the group consisting of carvone, citral, citronellal, eugenol, g-terpinene, geraniol, limonene, myrcene, nootkatone, trans-anethole and mixtures thereof.

11. The capsule according to claim 1 wherein said insectide is a larvicide.

12. The capsule according to claim 1 wherein said insecticide or repellent is spray dried to form particles and said particles are further encapsulated within said polymer which is crosslinked.

13. The capsule according to claim 1 wherein said insecticide is a larvicide and said larvicide is Bacillus thuringiensis (Bti).

14. The capsule according to claim 1 wherein said polymer is chitosan or beta-glucan.

15. The capsule according to claim 14 wherein said polymer is crosslinked with glutaraldehyde, gelatin or genipin.

16. The capsule according to claim 14 wherein said polymer is chitosan and said polymer is crosslinked with tripolyphosphate.

17. The capsule according to claim 1 wherein said polymer is alginic acid (alginate).

18. The capsule according to claim 17 wherein said alginic acid is crosslinked with a divalent cation.

19. The capsule according to claim 18 wherein said divalent cation is Ba²⁺, Mg²⁺, Ca²⁺, Sr²⁺ or a mixture thereof.

20. The capsule according to claim 19 wherein said divalent cation is Mg²⁺ or Ca²⁺.

21. The capsule according to claim 3 wherein said yeast-encapsulated larvicide is spray dried and crosslinked with chitosan before being encapsulated with crosslinked alginic acid.

22. The capsule according to claim 1 wherein said capsule comprises 0.5 to 15% by weight insecticide or repellent and 50% to 99.5%, 65% to 95% or 85% to 99.5% by weight crosslinked polymer.

23. The capsule according to claim 1 wherein said capsule comprises yeast-encapsulated larvicide.

24. The capsule according to claim 23 wherein said yeast-encapsulated larvicide comprises between 1% and 95% by weight and said crosslinked polymer comprises between 5% and 99% by weight.

25. The capsule according to claim 24 wherein said yeast-encapsulated larvicide comprises between 5% and 25% by weight and said crosslinked polymer comprises between 75% and 95% by weight.

26. The capsule according to claim 23 wherein said yeast-encapsulated larvicide comprises between 10% and 85% by weight and said crosslinked polymer comprises between 15% and 90% by weight.

27. The capsule according to claim 1 which includes an effective amount of a UV protective agent.

28. The capsule according to claim 27 wherein said UV protective agent is India ink, zinc oxide, lignin, lycopene, titanium dioxide, silicon dioxide, alumina/aluminum oxide or a mixture thereof.

29. A method of larval source management comprising exposing a target population of insect larvae to an effective amount of capsules according to claim 1.

30. The method according to claim 29 wherein said insect larvae is mosquito larvae, black fly larvae or fungus gnat larvae.

31. The method according to claim 29 wherein said larvae is larvae of Aedes spp., Culex spp. or Anopheles spp.

32. A method of reducing a target population of insect larvae in an environment comprising releasing an effective amount of capsules according to claim 1 under dry conditions within said environment and exposing said population to said capsules when said environment is wet.

33. The method according to claim 32 wherein said insect larvae is mosquito larvae, black fly larvae or fungus gnat larvae.

34. The method according to claim 32 wherein said larvae is larvae of Aedes spp., Culex spp. or Anopheles spp.

35. A method for forming a larvicidal capsule comprising encapsulating an essential oil or essential oil components within an ingestible yeast cell, removing any residual oil or residual essential oil components from the surface of the yeast cell to provide an essential oil or essential oil component containing yeast cell capsule and further encapsulating said essential oil or essential oil component containing yeast cell capsule in a polymeric coating comprising a crosslinked polymer selected from the group consisting of chitosan, a beta-glucan, an alginate (alginic acid) or a mixture thereof.

36. (canceled)

37. (canceled)

38. (canceled)

39. A method of reducing the population of a target species of insect comprising exposing said population to an effective number of capsules according to claim 1.
